(19) United States
(12) Patent Application Publication
(10) Pub. No.: US 2004/0035275 A1
(43) Pub. Date: Feb. 26, 2004

(54) ILLUMINATION DEVICE FOR MICROTOMES AND ULTRAMICROTOMES

(76) Inventors: Reinhard Lihl, Vienna (AT); Hubert Goll, St. Poelten (AT); Anton Lang, Vienna (AT)

Correspondence Address: SIMPSON & SIMPSON, PLLC, 5555 MAIN STREET, WILLIAMSVILLE, NY, 14221-5406, US

(21) Appl. No.: 10/604,135

(22) Filed: Jun. 27, 2003

(30) Foreign Application Priority Data
Jun. 28, 2002 (DE) DE10228985.9

(51) Int. Cl. B26D 7/00

(52) U.S. Cl. 83/520; 83/915.5

(57) ABSTRACT

The microtome or ultramicrotome comprises a knife (7) and a specimen arm (3) movable relative to the knife (7). At least one light source for illuminating a region around the preparation (5) is also provided. The at least one light source comprises at least one light-emitting diode (31, 41, 51).

### CROSS REFERENCE TO RELATED APPLICATIONS

This application claims priority of the German patent application 102 28 985.9 which is incorporated by reference herein.

### FIELD OF THE INVENTION

The invention concerns an illumination device for microtomes and ultramicrotomes. In particular, the invention concerns a microtome or ultramicrotome having a knife, a specimen arm movable relative to the knife, and at least one light source for illuminating a region around the preparation.

### BACKGROUND OF THE INVENTION

Illumination devices for microtomes presently exist. There are three different types of illumination that are used in microtomes and/or ultramicrotomes. One type of illumination is base-mounted illumination. During the operation of bringing the knife close to the preparation, this provides accurate monitoring of the distance between the two components. The light source should be mounted as close as possible below the knife so that when observed from above (e.g., with a stereomicroscope), the distance between knife and preparation appears as a bright strip of light (see Reichert Supernova, p. 4 “Flex optics,” Reichert Ultracut S pp. 4, 5, and 9 “Observation and illumination system”).

Halogen lamps are used as illumination sources, but because of their mechanical dimensions and also their heat emission, they cannot be brought close to the knife. The light is therefore transported via light guides to the vicinity of the knife.

In another type of illumination, internal preparation illumination, small incandescent bulbs or light guides are used to transilluminate the preparation (see Ultracut catalog p. 8). Specimen details become visible. Heat emission should be minimal.

German Patent DE 32 24 375 discloses an apparatus for checking the quality of the knife on a microtome. An observation microscope, as well as a base-mounted light source for illuminating the specimen/knife region, are provided for that purpose. To avoid displacement of the observation microscope and/or base-mounted light source for the purpose of checking the edge quality of the knife, provision is made for the knife holder, which is pivotable about the knife edge, to be sufficiently pivotable that the exposed surface of the knife edge encloses an angle of at least 20° with the beam path of the base-mounted light source.

German Patent DE 32 35 951 discloses a microtome, in particular an ultramicrotome, having a specimen carrier that is movable relative to a knife. To allow optimum illumination of the specimen and therefore an improved presentation of fine surface structures and the internal structure of the specimen, and to eliminate the need for readjustment of the illumination after changes in the specimen's position relative to the knife, provision is made for the light source to be arranged within the retaining opening of the specimen carrier, so that the specimen block made of transparent material, and therefore also the specimen, are transilluminated from behind.

German Patent DE 36 15 715 also discloses a microtome. The preparation to be cut is embedded in a specimen block made of transparent plastic. The specimen block is illuminated from the back side using a fiber optic cable.

The principal shortcoming of the aforementioned existing art is the heat emission of the illumination sources, which causes an expansion of the preparation and/or of the mechanical components of the microtome. Especially after an interruption in cutting, it may be very difficult to continue the cutting process because the first cut can be disproportionately thick due to expansion of the preparation.

A diamond knife that is usually used in ultramicrotomy has a maximum design load corresponding to sections 0.35 μm thick. Preparation expansion can cause this value to be exceeded, therefore resulting in damage to the knife. The need to supply power to the lamps also creates an additional space demand and cost for controlling and supplying power to the fluorescent lamps.

### SUMMARY OF THE INVENTION

It is therefore the object of the invention to create a microtome or an ultramicrotome which comprises an illumination system that is easy to install and maintain, and transfers no thermal effects to the microtome.

The aforesaid object is achieved by way of a microtome or an ultramicrotome having a knife, a specimen arm movable relative to the knife, and at least one light source acting as a base-mounted illumination system, at least one light source acting as an incident illumination system for and at least one light source acting as an internal preparation illumination system, wherein all illumination systems illuminate a region around the preparation and the at least one light source is at least one light-emitting diode.

A great advantage of the use of white LEDs is that the white light possesses a color temperature of approximately 5000 to 6000 K. Because of the shorter wavelengths, the bright gap is more clearly visible during the adjustment operation. Incident illumination shows more detail in the sections, which appear less clearly when fluorescent lamps are used. LED illumination also offers a substantial advantage for the user because of the more controlled adjustment operation and more accurate monitoring of cuts.

The microtome or ultramicrotome is equipped with a knife, a specimen arm movable relative to the knife, and at least one light source for illuminating a region around the preparation. The region around the preparation is defined by the knife, the gap between the knife and preparation, and the preparation itself. The at least one light source used for illumination is embodied as a light-emitting diode. The light-emitting diode can be configured as a base-mounted illumination system. Another possibility is to embody the light-emitting diode as an incident illumination system, and yet another possibility is to use the light-emitting diode as an internal preparation illumination system. Further advantageous embodiments of the invention are evident from the dependent claims.

### BRIEF DESCRIPTION OF THE DRAWINGS

The subject matter of the invention is depicted schematically in the drawings and will be described below with reference to the Figures, identically functioning elements being labeled with the same reference characters. In the drawings:

FIG. 1 is a side view of a microtome with a partial view into its interior;

FIG. 2 shows an embodiment of an incident illumination system according to the existing art;

FIG. 3 is a side view of a base-mounted illumination system having at least one light-emitting diode;

FIG. 4 is a front view of the base-mounted illumination system of FIG. 3;

FIG. 5 is a side view of an incident illumination system having several light-emitting diodes;

FIG. 6 is a frontal view of the incident illumination system of FIG. 5; and

FIG. 7 is a side view of an internal preparation illumination system.

### DETAILED DESCRIPTION OF THE INVENTION

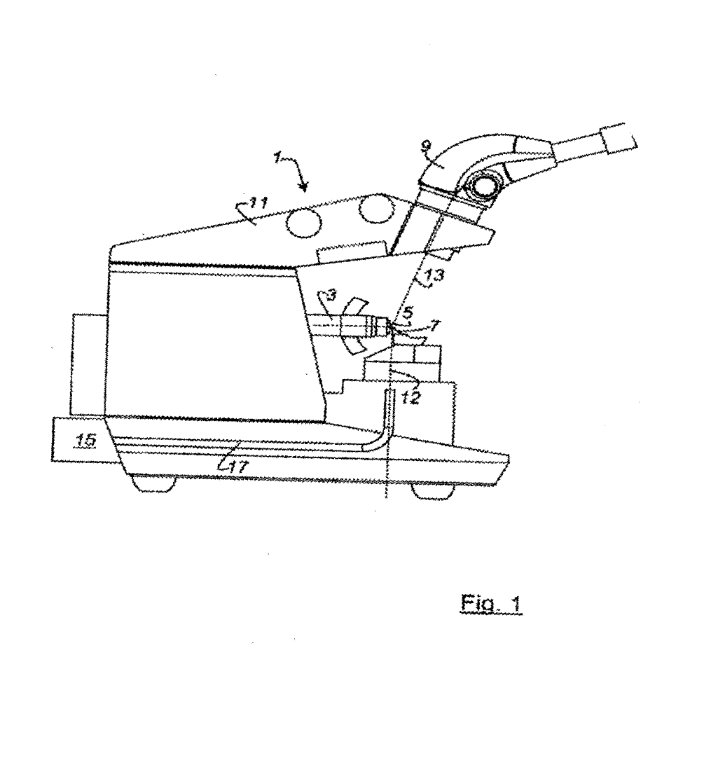

The microtome or ultramicrotome depicted in FIG. 1 has a specimen arm 3, movable up and down, on which a specimen or preparation 5 is mounted. In the description hereinafter, the alternative designation “microtome or ultramicrotome” will be dispensed with: it is clear to one skilled in the art that the term “microtome” 1 is understood to refer to several types. In the course of the up and down motion, preparation 5 is moved past the edge of a knife 7 so that a thin section is thereby produced. An observation microscope 9 is provided for checking the cutting operation and the quality of knife 7. Observation microscope 9 is attached to a support arm 11 of microtome 1. Observation microscope 9 defines an optical axis that is labeled 13. Provided for illumination of the knife 7/preparation 5 region is a base-mounted light source 15 whose light, in the exemplary embodiment described here, is guided with a light-guiding fiber 17 to the knife 7/preparation 5 region. Light-guiding fiber 17 is arranged in such a way that an upwardly directed beam 12 is produced, and illuminates the knife 7/preparation 5 region.

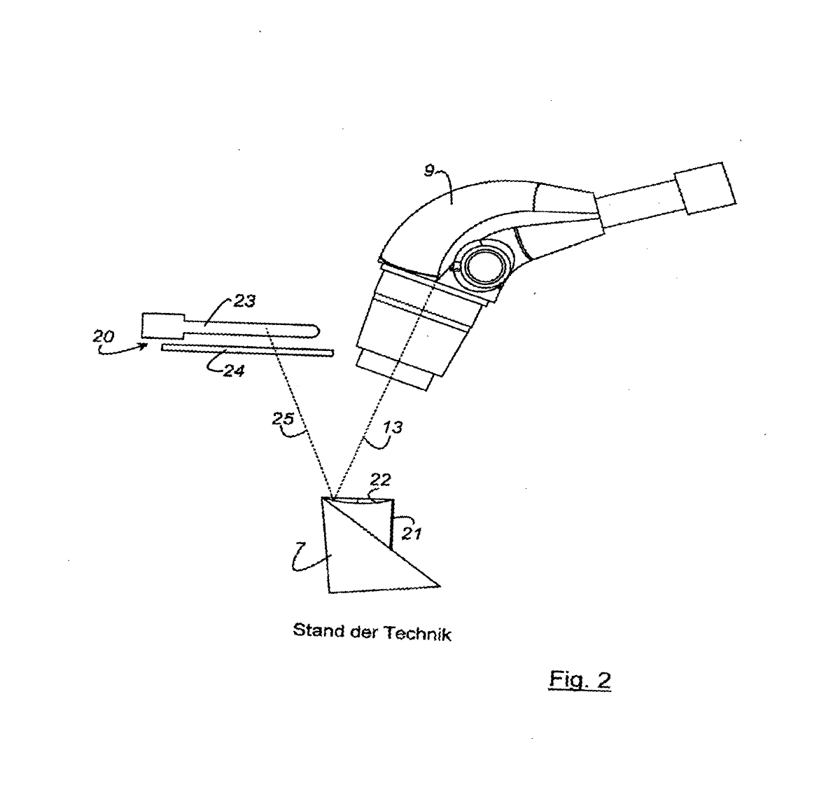

An incident illumination system according to the existing art is shown in FIG. 2. Here, as compared to FIG. 1, several parts of the microtome are omitted in order to provide a more detailed view. The microtome comprises an incident illumination system 20 that does not serve to illuminate the working region; instead, the light is intended to be reflected from a water-filled collection pan 21 for sections in the direction of optical axis 13 of observation microscope 9. Incident illumination system 20 defines an illumination direction 25 that is directed toward collection pan 21. A water surface 22 forms in collection pan 21, and reflection occurs from it in as uniform a fashion as possible in order to allow clear recognition of the sections with their interference colors. From the interference colors that form, the user can estimate the thickness of the sections. To prevent water bridges between knife 7 and the preparation (not depicted here) during cutting, a slightly recessed water surface 22 is often used. In the exemplary embodiment depicted here, water surface 22 is curved. To ensure uniform reflection even with such surfaces, fluorescent lamps 23 equipped with a frosted glass disk 24 are used for incident illumination system 20. The requisite size and position of the light-emitting surface are determined by the geometry of curved water surface 22. The heat emission of the illumination system is intended to be as low as Any heating of the preparation results in expansion and therefore in an increase in section thickness. The heat contributed by fluorescent lamps 23 also results in an unstable section thickness.

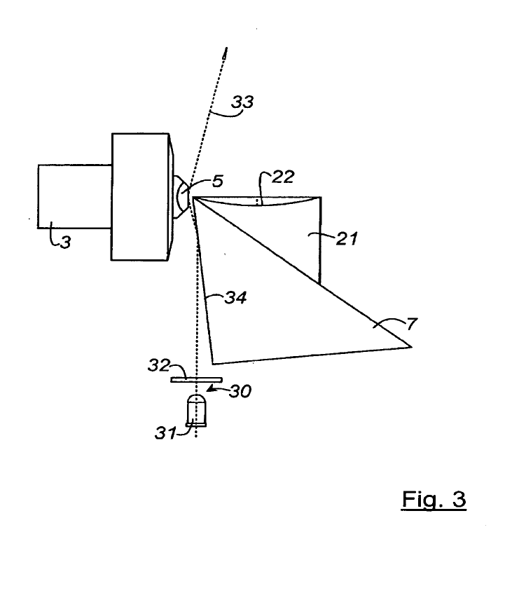

FIG. 3 schematically shows a first embodiment of the present invention. Once again, several parts of the microtome are omitted in order to focus on the essential parts of the invention. A base-mounted illumination system 30 is provided. Base-mounted illumination system 30 comprises at least one light-emitting diode 31 in front of which a frosted glass disk 32 can be placed. Base-mounted illumination system 30 is placed below knife 7, and defines a light beam 33. When light beam 33 emerging from base-mounted illumination system 30 coincides with the optical axis of the observation microscope, the gap between knife 7 and preparation 5 is bright. Light beam 33 is reflected by a back side 34 of the knife and at preparation 5. Frosted glass disk 32 makes the illumination of the gap more uniform.

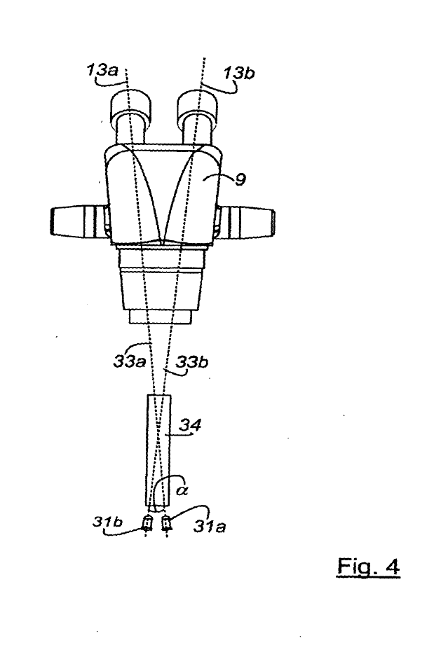

FIG. 4 shows a front view of the arrangement depicted in FIG. 3. Observation microscope 9 is a stereomicroscope, and defines a first and a second optical axis 13a and 13b. Base-mounted illumination system 30 comprises at least first and second light-emitting diodes 31a and 31b which each emit a light beam or ray bundle 33a and 33b that is reflected by back side 34 of the knife (cf. the depiction in FIG. 3). Because of the narrow emission angle of first and second light-emitting diodes 31a and 31b, the best illumination is obtained when at least one of light-emitting diodes 31a or 31b coincides with first or second optical axis 13a and 13b of observation microscope 9. First and second light-emitting diodes 31a and 31b are therefore inclined with respect to one another at an angle a which corresponds to the observation angle of observation microscope 9.

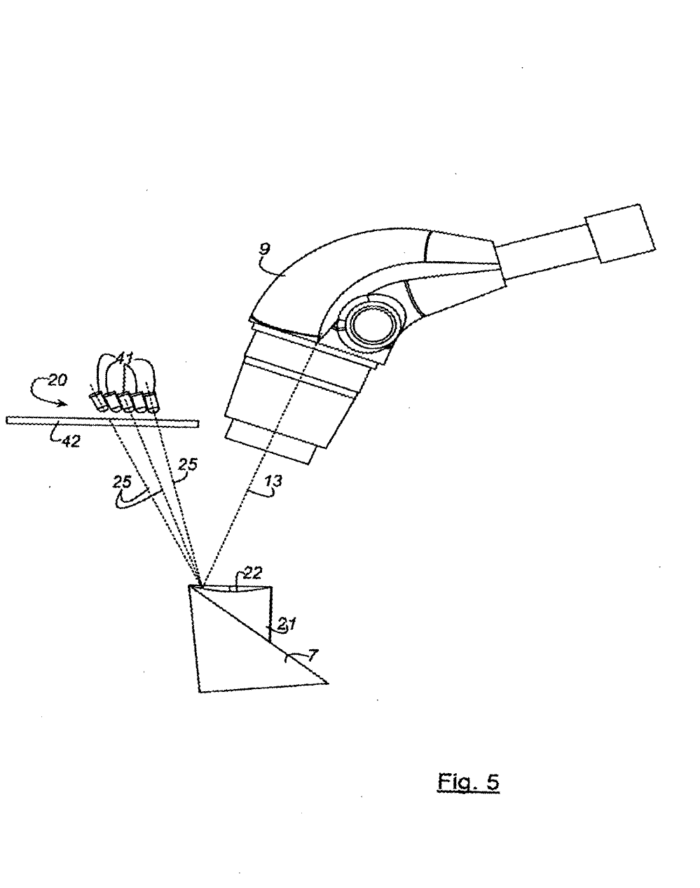

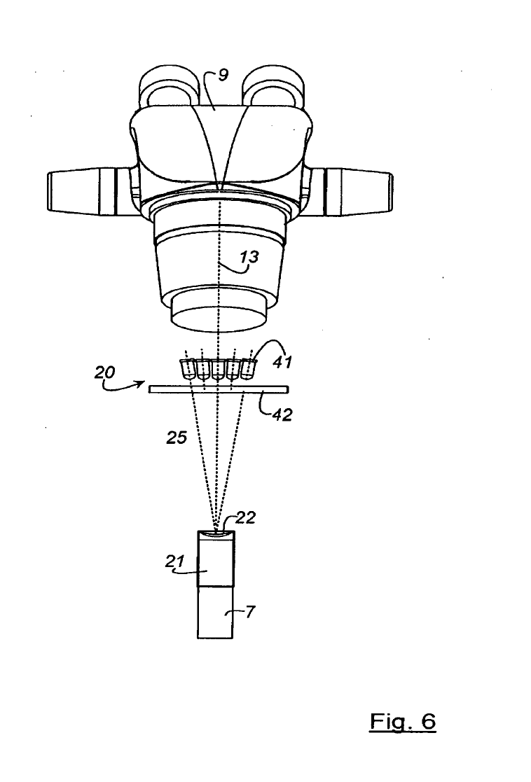

FIG. 5 shows the exemplary embodiment of the invention in which multiple light-emitting diodes 41 constitute incident illumination system 20 of FIG. 2. Light-emitting diodes 41 are arranged so as to yield optimum reflection conditions for a flat and a curved water surface 22. FIG. 5 shows a side view of this exemplary embodiment, and FIG. 6 depicts a front view thereof. In FIG. 5, only five light-emitting diodes 41 are shown schematically. This area in question is, however, on the order of a hundred light-emitting diodes. With a flat water surface, this light-emitting diode area can be smaller. But because a recessed water surface is often used to avoid water bridges to preparation 5 while cutting, the light-emitting diode area required increases as a function of the curvature of water surface 22. Light-emitting diodes 41 are once again inclined in order to optimize brightness. A frosted glass disk 42 below light-emitting diodes 41 is necessary in order to achieve uniform reflection from water surface 22. Incident illumination system 20 defines an illumination direction 25 that is directed toward collection pan 21. From water surface 22, the illuminating light is reflected in the direction of optical axis 13 of observation microscope 9. FIG. 6 shows a front view of what is depicted in FIG. 5. In this view as well, light-emitting diodes 41 are inclined and are oriented in the direction of water surface 22. The light emerging from light-emitting diodes 41 is thereby optimally directed into illumination direction 25 for water surface 22.

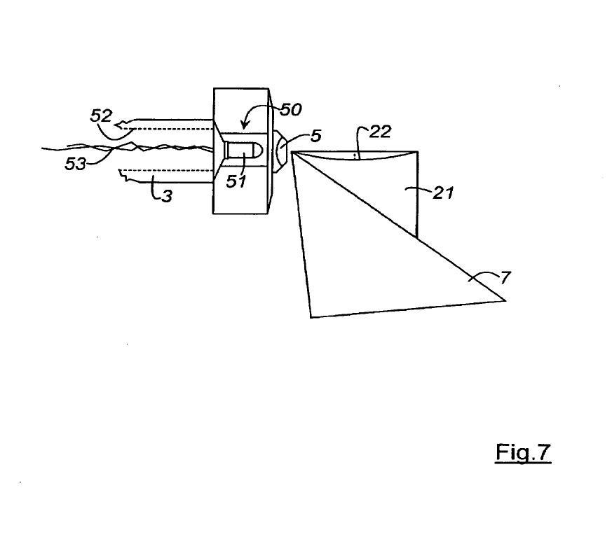

An internal preparation illumination system 50 (see FIG. 7) having at least one light-emitting diode 51 is also conceivable. The use of a light-emitting diode has, in this case, principally the great advantage of low heat emission as compared to miniature incandescent bulbs. The light-emitting diode is provided in specimen arm 3 behind preparation 5. Specimen arm 3 possesses a continuously open tube 52 in which electrical cables 53 for delivering current to light-emitting diode 51 are guided. As compared to a rather stiff light guide of the existing art, the advantage here is that cables 53 for supplying electricity can be made very flexible. The reason is that during cutting, even the slightest forces (e.g. through the light guides), caused by the fact that during cutting, the preparation is moved together with the illumination system but the light guide is connected to a stationary light source, are troublesome.

It is also conceivable to supply power to light-emitting diode 51 in specimen arm 3, or to all the light-emitting diodes of the microtome, using a battery without an external cable.

The invention has been described with reference to a particular exemplary embodiment. It is self-evident, however, that changes and modifications can be made without thereby leaving the range of protection of the claims below.

1. A microtome or ultramicrotome having a knife, a specimen arm movable relative to the knife, and at least one light source acting as a base-mounted illumination system, at least one light source acting as an incident illumination system for and at least one light source acting as an internal preparation illumination system, wherein all illumination systems illuminate a region around the preparation and the at least one light source is at least one light-emitting diode.

2. The microtome or ultramicrotome as defined in claim 1, wherein the base-mounted illumination system encompasses at least one light-emitting diode and a frosted glass disk mounted in front of the light-emitting diode.

3. The microtome or ultramicrotome as defined in claim 2, wherein the at least one light-emitting diode is mounted on the microtome in such a way that a light beam proceeding from the base-mounted illumination system is reflected by a back side of the knife and at the preparation so as thereby to achieve uniform illumination of the gap between the knife and preparation.

4. The microtome or ultramicrotome as defined in claim 3, wherein the base-mounted illumination system has a first and a second light-emitting diode which are inclined with respect to one another at an angle ( ), at least one of the light-emitting diodes coinciding respectively with a first or a second optical axis of an observation microscope.

5. The microtome or ultramicrotome as defined in claim 1, wherein the incident illumination system is formed of several light-emitting diodes.

6. The microtome or ultramicrotome as defined in claim 5, wherein the light-emitting diodes are arranged at an inclination in order to optimize brightness.

7. The microtome or ultramicrotome as defined in claim 5, wherein a frosted glass disk is provided between the light-emitting diodes and a water surface in a collection pan.

8. The microtome or ultramicrotome as defined in claim 7, wherein approximately hundred light-emitting diodes are arranged in planar fashion, and define an illumination direction that is directed toward the collection pan at the knife.

9. The microtome or ultramicrotome as defined in claim 1, wherein power is supplied to the light-emitting diodes via a battery.
